(19) United States
(12) Patent Application Publication
(10) Pub. No.: US 2007/0085802 A1
(43) Pub. Date: Apr. 19, 2007

(54) TIMING CONTROL METHOD AND DEVICE FOR LIQUID CRYSTAL DISPLAY

(75) Inventors: Hui-Lung Yu, Taipei County (TW); Yung-Zhi Wu, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORP., Hsinchu (TW)

(21) Appl. No.: 11/462,091

(22) Filed: Aug. 3, 2006

(30) Foreign Application Priority Data
Oct. 17, 2005 (TW) 94136136

(51) Int. Cl. G09G 3/36

(52) U.S. Cl. 345/98

(57) ABSTRACT

A timing control method and device for LCD panel is provided. The timing control device comprises a mode selection unit storing timing parameters corresponding to resolutions of the LCDs, with the timing parameters updateable; a video device outputting a video signal; and a logic unit receiving the video signal and fetching corresponding timing parameters according to a resolution of the video signal and outputting a control signal according to the timing parameter.

### BACKGROUND OF THE INVENTION

1. Field of the Invention

The invention relates to liquid crystal display (LCD), and in particular to an LCD having a timing controller with access to updateable timing parameters.

2. Description of the Related Art

LCDs receive video signals comprising pixel data and synchronization data. The pixel data comprises pixel color data. The synchronization data comprises vertical and horizontal synchronization data.

Density of an image frame, or resolution, is defined as pixel count per frame. Resolution is normally expressed in (horizontal pixel count) times (vertical pixel count). For example, a frame displaying 1024 horizontal pixels and 768 vertical pixels has a resolution of 1024*768.

Pixel data, delivered from upper-left corner to lower-right corner of the image, starts at the first pixel of the upper-left corner and moves right sequentially till the rightmost pixel, then to the leftmost pixel of the next line. Horizontal synchronization data is delivered with every leftmost pixel of a horizontal line to indicate a new horizontal line start. In this way all the pixel data is delivered, followed by first pixel data of the next frame. Vertical synchronization data is delivered with every first pixel data of the next frame to indicate a new frame start.

FIG. 1 is a block diagram of a conventional LCD 10. LCD 10 comprises a timing controller 11, driver 12 and display panel 13.

Timing controller 11 comprises a video device 111 receiving video data delivered to the LCD 10, a driving controller 112 outputting a drive signal to driver 12, a timing generator 113 outputting vertical and horizontal timing signals, and a timing and data control unit 114.

Timing and data control unit 114 comprises embedded timing parameters for signal timing setting corresponding to resolutions of LCD 10. Timing and data control unit 114 receives video signals from video unit 111, verifies resolution parameters using synchronization signals in the video signal, fetches corresponding timing parameters according to resolution of the video signal, and outputs a control signal according to the timing parameter. Control signal is delivered to the driving controller 112 and the timing generator 113.

Conventionally, timing parameters corresponding to all supported resolutions are embedded in a timing controller during design and manufacture, such that LCDs cannot process video data of a resolution not supported. As a result, when a new resolution is developed for video data signals, the timing controller must be redesigned.

### BRIEF SUMMARY OF THE INVENTION

The invention provides a timing controller for an LCD (liquid crystal display) panel, comprising a mode selection unit for storing timing parameters, adapted to be updated, corresponding to one of multiple resolutions of the LCDs, a video device for applying a video signal, and a logic unit for receiving the video signal and fetching corresponding timing parameters according to a resolution of the video signal and outputting a control signal according to the timing parameter.

The invention also provides an LCD comprising a display panel, a driver for driving the display panel, and a timing controller. The timing controller comprises a mode selection unit for storing timing parameters, adapted to be updated, corresponding to one of multiple resolutions of the LCD, a video device for outputting a video signal; and a logic unit for receiving the video signal and fetching corresponding timing parameters according to resolution of the video signal and for outputting a control signal according to the timing parameter.

The invention further provides a method of timing control for LCD, comprising providing a mode selection unit for storing timing parameters, adapted to be updated, corresponding to one of multiple resolutions of the LCD, receiving a video signal and fetching corresponding timing parameters according to a resolution of the video signal, and outputting a control signal according to the timing parameter.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a conventional LCD.

FIGS. 2A and 2B are block diagrams of a LCD according to embodiments of the invention.

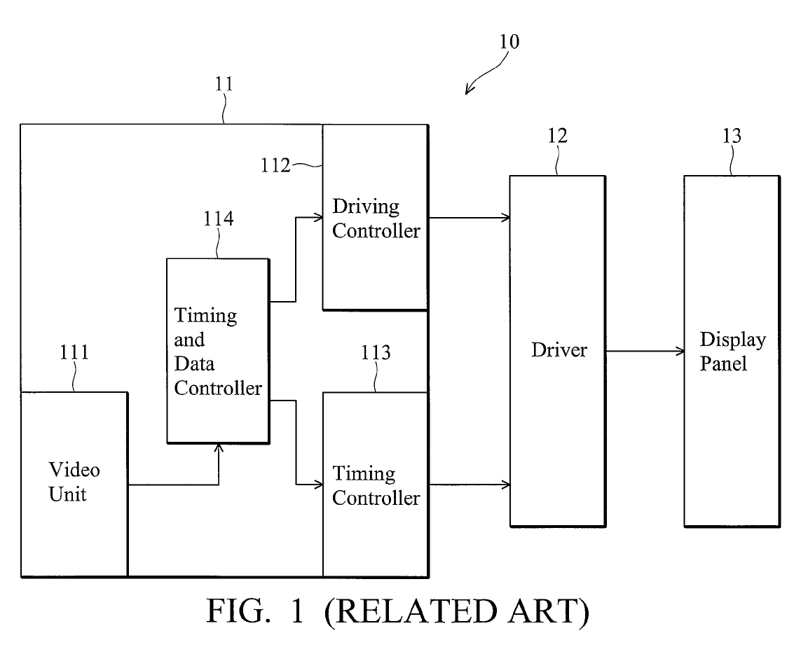

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

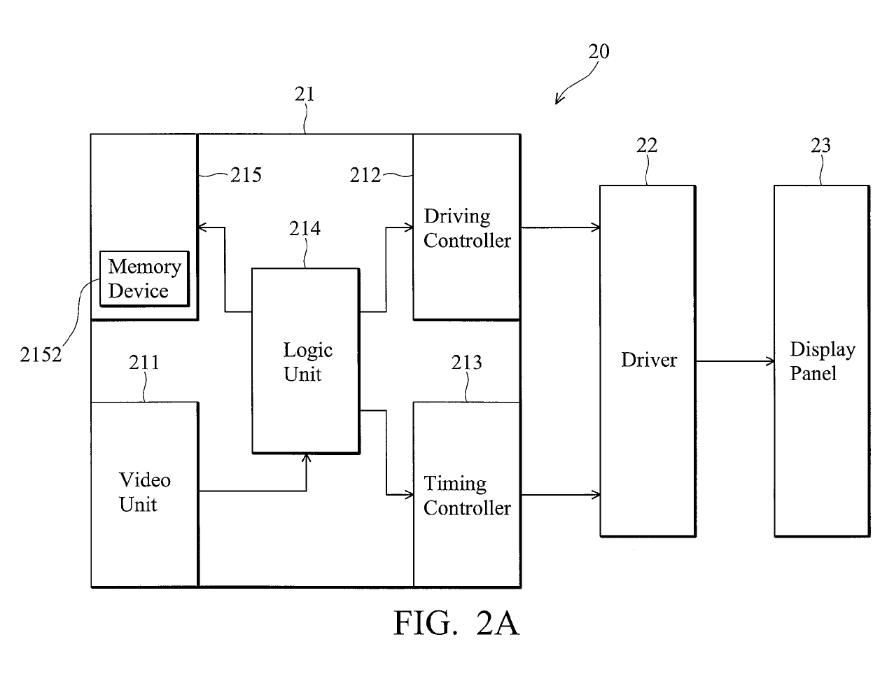

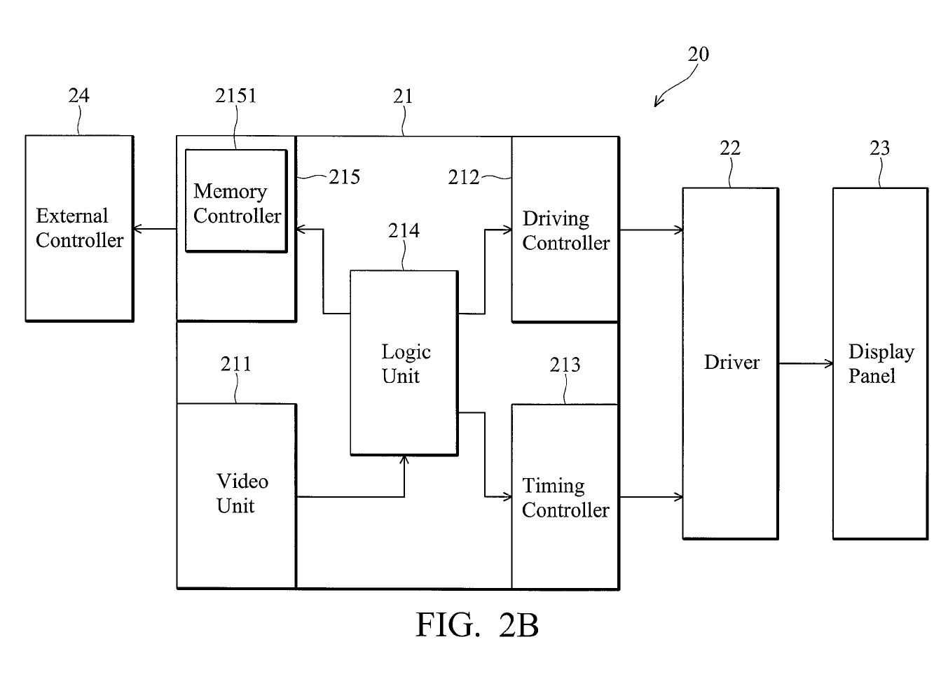

FIGS. 2A and 2B are block diagrams of LCD (liquid crystal display) 20 according to embodiments of the invention. LCD 20 comprises a timing controller 11, driver 12 and display panel 13.

Timing controller 21 comprises a video device 211 receiving video data delivered to the LCD 20, a driving controller 212 outputting a driving signal to driver 22, a timing generator 213 outputting vertical and horizontal timing signals, adapted to updated, a logic unit 214, and a mode selection unit 215 for storing timing parameters for signal timing setting corresponding to one of multiple resolutions of LCD 10.

Logic unit 214 receives video signals from video unit 211, verifies resolution properties using synchronization signals in the video signal. Logic unit 214 then fetches corresponding timing parameters according to a resolution of the video signal from mode selection unit 215, and outputting a control signal according to the timing parameter. The control signal is delivered to the driving controller 112 and the timing generator 113.

Mode selection unit 215 may comprise a memory device 2152, as shown in FIG. 2A. Memory device 2152 can be an electronic erasable programmable read only memory (EEPROM) device storing timing parameters. Otherwise, mode selection unit 215 may comprise an external controller 24 and a memory controller 2151 coupled to the external controller 24, as shown in FIG. 2B. External controller 24 can be an EEPROM device storing timing parameters, and alternatively can be disposed inside the timing controller 21 (not shown in FIG. 2B). Mode selection unit 215 then reads timing parameters of external controller 24 through memory controller 2151.

According to the invention, a timing device in an LCD can fetch timing parameters from an internal memory or external controller. When new resolution specifications are developed, new timing parameters can be updated with ease. Competitiveness of the LCD product is increased due to low upgrade cost.

Additional functions can be implemented by the provided scheme.

Logic device 214 of FIGS. 2A and 2B can further comprise pixel color transforming function, according to another embodiment of the invention in which mode selection unit 215 further comprises a color mapping table mapping an input color of a pixel Ai=(Ri, Gi, Bi) to a color Bi=(Ri′, Gi′, Bi′) received by the driver 212, according to environmental factors or user requirements, with i being pixel location. Logic device 214 performs a Bi=f(Ai) calculation, and the selection unit 215 comprises parameters required for the f(Ai) calculation. Color enhancement, color temperature adjust and gamma adjust functions can therefore be implemented.

Logic device 214 of FIGS. 2A and 2B can further comprise frame enhancement function, according to another embodiment of the invention. For example, a pixel Aj can be kept in a maximum difference Aj=[f₁(ai), f₂(ai)], wherein Ai is a pixel adjacent to Aj. A data value out of the range can be caused by noise and must be adjusted back within the rage. Logic device 214 performs the f₁(ai) and f₂(ai) calculation, and the selection unit 215 comprises parameters required for the f₁(ai) and f₂(ai) calculation. Frame enhancement function such as noise reduction can therefore be implemented.

Logic device 214 of FIGS. 2A and 2B can further comprise security function, according to another embodiment of the invention. Mode selection unit 215 can further store encoded security parameters. Logic unit 214 further fetches and verifies the security parameters and restrains functions of the LCD when the security parameters are incorrect. Therefore correct security parameters are required before the LCD can function normally, to prevent illegal copy of system design from happening.

While the invention has been described by way of example and in terms of the embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A timing controller for a liquid crystal display (LCD), comprising:
a mode selection unit for storing timing parameters, adapted to be updated, corresponding to one of multiple resolutions of the LCD;
a video device for applying a video signal; and
a logic unit for receiving the video signal and fetching corresponding timing parameters according to a resolution of the video signal, and outputting a control signal according to the timing parameter.

2. The timing controller as claimed in claim 1, wherein the mode selection unit comprises a memory device.

3. The timing controller as claimed in claim 2, wherein the mode selection unit further comprises an external controller and a memory controller coupled to the logic unit.

4. The timing controller as claimed in claim 1, further comprising:
a drive controller for receiving the control signal and for outputting a drive signal accordingly; and
a timing generator for receiving the control signal and outputting vertical and horizontal timing signals accordingly.

5. The timing controller as claimed in claim 4, wherein the control signal comprises drive data, and vertical and horizontal timing data.

6. The timing controller as claimed in claim 1, wherein the mode selection unit further stores color transforming parameters, and the logic unit fetches the color transforming parameters and outputs the control signal accordingly.

7. The timing controller as claimed in claim 1, wherein the mode selection unit further stores frame enhancement parameters, and the logic unit further fetches the frame enhancement parameters and outputs the control signal accordingly.

8. The timing controller as claimed in claim 1, wherein the mode selection unit further stores security parameters, and the logic unit further fetches and verifies the security parameters and restrains functions of the LCD when the security parameters are incorrect.

9. A liquid crystal display (LCD) comprising:
a display panel;
a driver for driving the display panel; and
a timing controller comprising:
a mode selection unit for storing timing parameters, adapted to be updated, corresponding to one of multiple resolutions of the LCD;
a video device for outputting a video signal; and
a logic unit for receiving the video signal and fetching corresponding timing parameters according to a resolution of the video signal, and for outputting a control signal according to the timing parameter.

10. The LCD as claimed in claim 9, wherein the mode selection unit comprises a memory device.

11. The LCD as claimed in claim 10, wherein the mode selection unit further comprises an external controller and a memory controller coupled to the logic unit.

12. The LCD as claimed in claim 9, further comprising:
a drive controller for receiving the control signal and for outputting a drive signal accordingly; and
a timing generator for receiving the control signal and for outputting vertical and horizontal timing signals accordingly.

13. The LCD as claimed in claim 12, wherein the control signal comprises drive data, and vertical and horizontal timing data.

14. The LCD as claimed in claim 9, wherein the mode selection unit further stores color transforming parameters, and the logic unit further fetches the color transforming parameters and outputs the control signal accordingly.

15. The LCD as claimed in claim 9, wherein the mode selection unit further stores frame enhancement parameters, and the logic unit further fetches the frame enhancement parameters and outputs the control signal accordingly.

16. The timing controller as claimed in claim 9, wherein the mode selection unit further stores security parameters, and the logic unit further fetches and verifies the security parameters and restrains functions of the LCD when the security parameters are incorrect.

17. A method of timing control for liquid crystal display (LCD), comprising:
providing a mode selection unit for storing timing parameters adapted to be updated, corresponding to one of multiple resolutions of the LCD;
receiving a video signal and fetching corresponding timing parameters according to a resolution of the video signal, and
outputting a control signal according to the timing parameter.

18. The method as claimed in claim 17, further comprising:
receiving the control signal and outputting a driving signal accordingly; and
receiving the control signal and outputting vertical and horizontal timing signals accordingly.
